(19) United States
(12) Patent Application Publication
(10) Pub. No.: US 2022/0134892 A1
(43) Pub. Date: May 5, 2022

(54) ENERGY PROVISION DEVICE

(71) Applicant: AUDI AG, Ingolstadt (DE)

(72) Inventor: Tobias GRAßL, Denkendorf (DE)

(73) Assignee: AUDI AG, Ingolstadt (DE)

(21) Appl. No.: 17/275,887

(22) PCT Filed: Oct. 11, 2018
(86) PCT No.: PCT/EP2018/077736

§ 371 Date: Mar. 12, 2021

(30) Foreign Application Priority Data
Oct. 11, 2017 (DE) 10 2017 218 165.6
Sep. 14, 2018 (DE) 20 218 004 274.9

(51) Int. Cl. B60L 53/12; B60L 53/14

(52) U.S. Cl. CPC B60L 53/12; B60L 2210/30; B60L 2210/40; B60L 53/14

(57) ABSTRACT

An energy provision device for providing electrical energy for a motor vehicle, including a network connection for connecting the energy provision device to an AC network, at least one first connection device for creating a wired electrical connection between the network connection and the motor vehicle, and at least one second connection device for creating a wireless electrical connection between the network connection and the motor vehicle. The first connection device has a connection for connecting an electrical line provided for creating the wired connection to the motor vehicle and/or the electrical line connected to the connection and the second connection device has a wireless charging device.

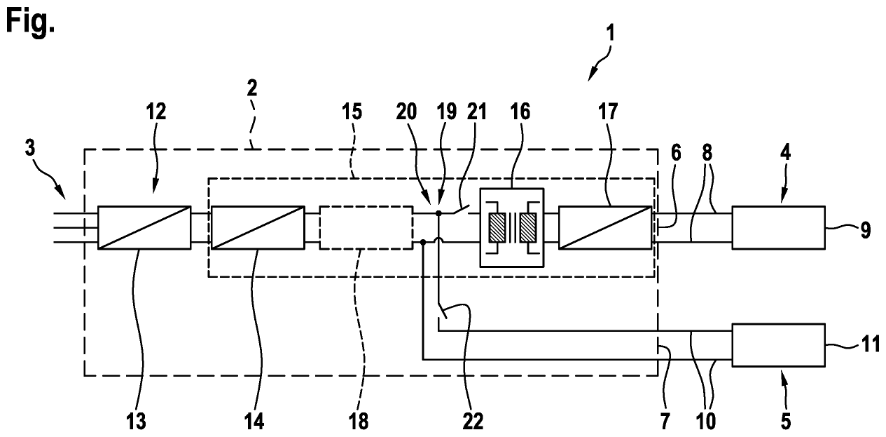

### FIELD

The invention relates to an energy provision device for providing electrical energy for a motor vehicle, comprising a network connection for connecting the energy provision device to an AC network, comprising at least one first connection device for creating a wired electrical connection between the network connection of the motor vehicle, and comprising at least one second connection device for creating a wireless electrical connection between the network connection and the motor vehicle, wherein the first connection device has a connection for connecting an electrical line provided for creating the wired connection to the motor vehicle and/or the electrical line connected to the connection and the second connection device has a wireless charging device.

### BACKGROUND

For example, document DE 10 2010 022 727 A1 is known from the prior art. It relates to a charging system for charging the traction battery of an electrically driven motor vehicle, comprising a first rectifier, which is galvanically connectable on the input side to an AC voltage or three-phase supply network and is connected on the output side via an intermediate circuit provided for stabilizing the generated DC voltage to the input of a charge regulating circuit connected on the output side to the traction battery. It is provided here that the intermediate circuit is connected to the output of a second rectifier, which is connected on the input side to a vehicle-side electrical winding, via which electrical energy can be inductively transferred to the motor vehicle from a charging station connected to an AC voltage supply network or three-phase supply network using a coupling device attachable to the motor vehicle and comprising a stationary electrical winding.

Furthermore, document FR 2 985 868 A1 describes a charging system for batteries of a motor vehicle and document DE 11 2012 005 145 T5 describes a quick charge power supply system.

Furthermore, document DE 10 2013 220 548 A1 discloses a device for charging an electrical energy accumulator comprising a first device for receiving electrical energy, which has a receiver for contactlessly receiving the electrical energy, and comprising a second device for receiving electrical energy, which has a connection that can be contacted for the wired receiving of the electrical energy, wherein the first and the second device are alternately usable to charge the energy accumulator. It is provided that the first device is connected to the second device, and that only the second device is connected to the energy accumulator.

Furthermore, document DE 10 2016 102 053 A1 discloses a circuit system for a charging station, which is provided for charging an energy accumulator in a vehicle, wherein the circuit system comprises a transformer having transformer outputs galvanically isolated from one another, wherein a first subsystem and a second subsystem are each connected to one of the transformer outputs, wherein the first subsystem and the second subsystem each comprise a rectifier, from which a DC voltage converter is connected upstream, wherein the DC voltage converter is coupled on its input side or on its output side to a switching logic.

Finally, document EP 2 657 063 A1 describes a charging device for installation in an electric vehicle for charging an electric energy accumulator of the electric vehicle, wherein the charging device has a first energy transfer interface, which is connected via a first electric energy path to an energy-accumulator-side connection. It is provided here that the charging device has a second energy transfer interface, which is connected via a second electric energy path to the energy-accumulator-side connection, and that the second electric energy path discharges into the first electric energy path, wherein the common section of the energy paths between the discharge of the second electrical energy path into the first electrical energy path and the energy-accumulator-side connection has at least one electrical component.

### SUMMARY

It is the object of the invention to propose an energy provision device for providing electrical energy for a motor vehicle, which has advantages over known energy provision devices, in particular is usable extremely flexible with small structural space at the same time.

This is achieved according to the invention by an energy provision. It is provided that the first connection device and the second connection device are connected to the network connection via a common network rectifier device and a common inverter of a potential isolation device, wherein the potential isolation device has a rectifier electrically connected on the input side to the inverter and on the output side to the first connection device as well as an isolation transformer comprising a primary winding electrically connected to the inverter and a secondary winding electrically connected to the first connection device, and wherein the second connection device is electrically connected to the potential isolation device between the inverter and the rectifier.

The energy provision device is used to provide electrical energy for the motor vehicle. For this purpose, the energy provision device is connected via its network connection to the AC network, preferably a public AC network, or is at least connectable thereto. The energy provision device can withdraw electrical energy from the AC network via the network connection and provide it to the motor vehicle or transfer it to the motor vehicle. The energy transferred to the motor vehicle is used, for example, for charging an energy accumulator of the motor vehicle, preferably a traction battery of the motor vehicle. The traction battery is to be understood as an energy accumulator which is used to operate a traction drive of the motor vehicle, i.e., an electrical machine, by means of which the electrical energy temporarily stored in the traction battery can be converted into mechanical energy, which is directed to driving the motor vehicle.

The energy provision device can transfer the electrical energy supplied via the network connection to the motor vehicle in a wired manner, on the one hand, and wirelessly, on the other hand. For this purpose, the energy provision device can alternately be used to create the wired electrical connection and/or the wireless electrical connection. To create the wired electrical connection, the energy provision device has the first connection device and to create the wireless connection device it has the second connection device. Both the first connection device and also the second connection device are each embodied accordingly to create the respective electrical connection.

It is provided that the first connection device has the connection for connecting the electrical line provided for creating the wired connection to the motor vehicle and/or the electrical line connected to the connection. The wired connection to the motor vehicle can be created or is created via the first connection device. For this purpose, the energy provision device is associated at least with the connection for connecting the electrical line, via which the wired electrical connection to the motor vehicle is ultimately provided. The connection is, for example, a plug fitting, which provides a plug connection, via which the electrical line is electrically connectable to the first rectifier.

Of course, the electrical line can additionally be part of the first connection device. For example, the line is detachably connectable nondestructively to the connection, i.e., it is connectable to the connection in such a way that it can subsequently be detached or isolated again from the connection nondestructively. It can also be provided that the electrical line is electrically connected permanently and non-detachably, i.e., not detachable nondestructively, to the first rectifier. In this case, for example, only the electrical line is provided, but not the connection or plug fitting.

The plug fitting is arranged, for example, on a housing of the energy provision device in such a way that the plug connection to the electrical line can be created easily. This enables extremely flexible usage of the energy provision device. The first connection device is provided and designed for transferring a direct current to and/or from the motor vehicle or a direct current is transferred from or to the motor vehicle by means of the first connection device.

Furthermore, it is provided that the second connection device has the wireless charging device. An alternating current is transferred from and/or to the motor vehicle with the aid of the second connection device. During a transfer of the alternating current to the motor vehicle, the alternating current is supplied to the wireless charging device. The wireless charging device is provided, for example, in the form of one or more coils. By means of the energy provision device, for the wireless provision of the electrical energy for the motor vehicle, the alternating current withdrawn from the alternating current is first converted by means of the network rectifier device into direct current. Subsequently, this direct current is converted back into alternating current, namely by means of the common inverter. In this case, the frequency of the alternating current is converted to the requirements of the wireless charging device. In particular, the frequency of the alternating current provided by means of the inverter is higher than the frequency of the alternating current withdrawn via the network connection from the AC network. A flexible operation of the energy provision device is thus possible.

Alternating current from the AC network is provided to the energy provision device via the network connection. Only the second connection device is operable using alternating current, however, and thus requires alternating current for its intended operation. In contrast, the first connection device is operated using direct current or requires direct current for its intended operation. To achieve a particularly compact embodiment of the energy provision device, the first connection device and the second connection device are electrically connected in parallel to the network connection. This is carried out via the common network rectifier device and the common inverter.

The network rectifier device is used to convert alternating current provided at the network connection into direct current, wherein the latter is provided to the first connection device and the second connection device, namely via the inverter of the potential isolation device. The potential isolation device is used for a galvanic isolation of at least the first connection device and the network connection. This means that the network connection and the first connection device are free of potential in relation to one another, because their electrical potentials are isolated from one another. In this way, a high level of safety of the energy provision device is achieved, because a user of the energy provision device is not subjected to an electric current flow even upon simultaneously touching the energy provision device and the motor vehicle, and he thus does not get an electrical shock. The potential isolation device is used in particular for the isolation of the electrical potentials of the network connection and the first connection device, because otherwise a galvanic connection would exist between the energy provision device and the motor vehicle. This is not the case for the second connection device due to the wireless energy transfer. Additionally or alternatively, however, the potential isolation device can be provided and designed to implement a galvanic isolation between the network connection and the second connection device.

The potential isolation device preferably has, in addition to the inverter, an isolation transformer and furthermore preferably a rectifier. The rectifier is connected here, for example, via the isolation transformer to the inverter. The inverter converts the DC voltage provided by the network rectifier device into an AC voltage, which is transformed by the isolation transformer into a further AC voltage. This further AC voltage is converted with the aid of the rectifier into a DC voltage, which is ultimately provided to the first connection device. In other words, the first connection device is preferably connected via the rectifier to the isolation transformer, the rectifier is connected via the isolation transformer and the inverter, and the isolation transformer is connected via the inverter to the network rectifier device. In this way, the galvanic isolation of the first connection device from the network connection is achieved. If the galvanic isolation of the second connection device from the network connection is additionally or alternatively implemented, the second connection device is thus connected via the isolation transformer to the inverter and—as already explained—the isolation transformer is connected via the inverter to the network rectifier arrangement.

The electrical energy provided at the network connection in the form of the alternating current can be provided to the motor vehicle by means of the first connection device, the second connection device, or both simultaneously. It can thus be provided that the provision of the electrical energy for the motor vehicle takes place solely by means of the first connection device or solely by means of the second connection device. However, it can also be provided that the electrical energy is provided to the motor vehicle by means of both the first connection device and also the second connection device, i.e., in parallel or simultaneously.

In any case, however, the first connection device and the second connection device are supplied with electrical energy indirectly by means of the common network rectifier circuit, in particular exclusively by means of the common network rectifier circuit. Because of the use of the common network rectifier circuit for the first connection device and the second connection device, a space-saving embodiment of the energy provision device can be implemented, but a high level of flexibility in the use of the energy provision device can be achieved at the same time, because electrical energy can be provided to the motor vehicle or the motor vehicles in both a wired and also a wireless manner. It can also be provided that electrical energy is provided to the motor vehicle by means of the first connection device and electrical energy is provided to a further motor vehicle by means of the second connection device.

The network rectifier device can be designed to be unidirectional or bidirectional. In the first case, electrical energy can be withdrawn from the AC network by means of the network rectifier device and supplied to the connection devices. The reverse direction is not provided. In contrast, if the bidirectional design of the network rectifier device is implemented, the network rectifier device can be used both to withdraw electrical energy from the AC network and supply it to the connection devices and also to transfer energy in the reverse direction. This means that, for example, energy from the motor vehicle can be transferred by means of the first connection device and/or the second connection device to the energy provision device and supplied therefrom via the network rectifier device to the AC network.

Due to the integration of the first connection device and the second connection device into the energy provision device, it can moreover be provided that electrical energy is withdrawn from the motor vehicle by means of one of the connection devices and supplied by means of the respective other of the connection devices to the further motor vehicle. Extremely flexible operation of the energy provision device is thus implemented or at least implementable. For example, for this purpose a rectifier of the potential isolation device and/or the second connection device is designed to be bidirectional.

One preferred further embodiment of the invention provides that the network rectifier device has a network rectifier which is electrically connected, on the one hand, to the network connection and, on the other hand, via the common inverter in parallel to the first connection device and the second connection device. The network rectifier is used to rectify the alternating current withdrawn from the AC network into direct current, which is subsequently provided to the first connection device and the second connection device via the common inverter. For this purpose, the network rectifier is connected on the input side to the network connection and is connected on the output side via the inverter of the potential isolation device to both the first connection device and also the second connection device.

The electrical power supplied in total to the first connection device and the second connection device is thus conducted via the network rectifier. The energy provision device is preferably thus adapted accordingly. For example, the network rectifier is designed in such a way that it can supply the first connection device and the second connection device as a whole with electrical power which corresponds to the total of the rated powers of the two connection devices. If this is not the case, thus if the rated power of the network rectifier is less than the total of the rated power of the two connection devices, the energy provision device is thus preferably designed in such a way that either only one of the two connection devices is operable in each case, or that the actual power of at least one of the two connection devices is set in such a way that it is less than the respective rated power.

In the first case, for example, the second connection device is thus shut down when electrical energy is supplied to the motor vehicle by means of the first connection device. Vice versa, the first connection device is shut down when electrical energy is supplied to the motor vehicle by means of the second connection device. Instead of the shutdown, a reduction of the actual power of the corresponding connection device can also be provided in each case, namely preferably in such a way that the total of the actual powers of the two connection devices corresponds to the rated power of the network rectifier or the network rectifier device.

Of course, the network rectifier device can have multiple network rectifiers, which are preferably arranged in parallel to one another in this case. The network rectifiers are thus electrically connected, on the one hand, to the network connection and in each case, on the other hand, to the potential isolation device or the common inverter of the potential isolation device.

The invention provides that the potential isolation device has a rectifier which is electrically connected on the input side to the inverter and on the output side to the first connection device. The potential isolation device thus has the rectifier in addition to the inverter. The rectifier is electrically connected via the inverter to the network rectifier device or the network rectifier. Moreover, the first connection device is connected via the rectifier to the inverter. The rectifier is used for rectifying an alternating current into a direct current. The alternating current is provided by the inverter, namely by converting the direct current provided by the network rectifier device into alternating current. The direct current ultimately provided by the rectifier is supplied to the first connection device for transfer to the motor vehicle. The motor vehicle is preferably connectable directly to the rectifier via the first connection device. The direct current provided by the rectifier is thus supplied directly via the first connection device to the motor vehicle. The use of the rectifier enables a particularly low-loss transfer of electrical energy to the motor vehicle in the form of direct current.

In the scope of the invention, it is provided that the potential isolation device has an isolation transformer comprising a primary winding and a secondary winding, wherein the primary winding is electrically connected to the inverter and the secondary winding is electrically connected to the first connection device. The isolation transformer effectuates the actual galvanic isolation which is achieved by means of the potential isolation device. The isolation transformer has the primary winding and the secondary winding, which are electrically isolated from one another, preferably by a protective isolation. For this purpose, a reinforced insulation can be provided between the primary winding and the secondary winding. The isolation transformer can also be designed as a conventional transformer, however.

The isolation transformer does not carry out voltage conversion, for example, so that an electric voltage on the primary winding corresponds to an electric voltage on the secondary winding. Alternatively, however, such a voltage conversion can be provided, of course, wherein, for example, the electric voltage provided on the secondary winding is greater or less than the electric voltage provided on the primary winding.

The primary winding is electrically connected to the inverter and the secondary winding is electrically connected to the first connection device. The alternating current provided by the inverter is thus applied to the primary winding, which is converted by the isolation transformer into an alternating current provided on the secondary winding. This alternating current is provided to the first connection device, in particular via the rectifier. The use of the isolation transformer results in a particularly safe and reliable embodiment of the energy provision device.

One refinement of the invention provides that the network rectifier is designed for rectifying an electric current provided at the network connection at a network frequency and the inverter provides electric current at an intermediate circuit frequency, which is greater than the network frequency, on the output side. During intended operation of the energy provision device, an electric current is thus applied to the network connection which has the network frequency. This electric current or alternating current is rectified with the aid of the network rectifier device, i.e., converted into a direct current. This direct current is in turn converted with the aid of the inverter into an alternating current, wherein this alternating current has the intermediate circuit frequency.

To achieve a particularly compact embodiment of the energy provision device, the intermediate circuit frequency is higher than the network frequency. Due to the higher frequency, the transformer can be designed to be smaller than would be the case if the intermediate circuit frequency corresponded to the network frequency. The intermediate circuit frequency is particularly preferably significantly higher than the network frequency, preferably by a factor of at least 10, at least 100, or at least 1000. For example, the network frequency is at most 50 Hz or at most 60 Hz, while in contrast the intermediate circuit frequency is at least 1 kHz, at least 10 kHz, at least 25 kHz, at least 50 kHz, at least 75 kHz, or at least 85 kHz.

One preferred refinement of the invention provides that the wireless charging device is designed for intended operation at a transfer frequency and the intermediate circuit frequency corresponds to the transfer frequency. The transfer frequency is, for example, at least 1 kHz, at least 10 kHz, at least 25 kHz, at least 50 kHz, at least 75 kHz, or at least 85 kHz. A particularly efficient energy transfer from and to the motor vehicle can be achieved at such a transfer frequency. It is provided that the inverter of the potential isolation device is to be used to provide the alternating current necessary for the operation of the second connection device. A separate inverter for the second connection device can thus be omitted, so that the resulting energy provision device is particularly compact.

A further embodiment of the invention provides that at least one electrical component of a resonant circuit and/or a filter and/or a compensation network is electrically connected between the inverter and the isolation transformer. The resonant circuit represents a resonance-capable electrical circuit, which has as electrical components at least one coil and one capacitor. In contrast, the filter is an electrical circuit which filters out specific frequencies from the electrical alternating current provided by the inverter. The filter has as an electrical component at least one coil and/or one capacitor. The compensation network is used to compensate for a leakage inductance. The use of the resonant circuit and/or the filter and/or the compensation network enables a particularly effective energy transfer from or to the motor vehicle.

According to the invention, it is provided that the second connection device is electrically connected between the inverter, in particular the at least one electrical component, and the rectifier, in particular the isolation transformer, to the potential isolation device. The second connection device is thus not electrically connected via the entire potential isolation device to the network rectifier device, but rather to a connection which branches off from the potential isolation device. For this purpose, the second connection device is electrically connected to the potential isolation device between the inverter and the rectifier. It can be provided that it is connected between the at least one electrical component of the resonant circuit or the filter and the rectifier, between the inverter and the isolation transformer, or between the at least one electrical component and the isolation transformer. In this way, the inverter can be used in a particularly efficient manner for providing alternating current for the second connection device.

One preferred further embodiment of the invention provides that the first connection device and the second connection device are connected via a switching device to the inverter. By means of the switching device, at least one of the connection devices, i.e., the first connection device and/or the second connection device, can be electrically isolated from the inverter, at least in one phase or—alternatively—in multiple phases. The switching device enables efficient operation of the energy provision device by switching off in each case those of the connection devices which are presently not required.

In the scope of a further preferred embodiment of the invention, it is provided that the switching device has at least one switch which is connected, on the one hand, to an electrical connection point provided between the inverter in the rectifier to the potential isolation device and, on the other hand, is connected to the first connection device and/or the second connection device. The switch of the switching device is thus electrically connected in the potential isolation device to this device, namely at the connection point. This point is electrically located between the inverter, in particular the at least one electrical component, and the rectifier, in particular the isolation transformer.

The switch is connected, on the one hand, to the connection point and, on the other hand, to one of the connection devices. This connection device can be either electrically connected to the connection point or isolated from it with the aid of the switch. In a first switch position of the switch, the connection device is electrically connected to the connection point and in a second switch position it is isolated from it. Such a switch is preferably associated with each of the connection devices. For example, the switching device thus has a first switch for the first connection device and a second switch for the second connection device. The above statements are to be used in each case for the switches for the first switch and the second switch. The first switch is electrically provided between the connection point and the first connection device and the second switch is electrically provided between the connection point and the second connection device. With the aid of the switch or the switches, flexible operation of the energy provision device is implementable.

A further preferred embodiment of the invention provides that the network rectifier device and the potential isolation device are arranged in a common housing of the energy provision device. The connection of the first connection device is also preferably provided on or in the housing. The common housing is provided, for example, for a wall mounting, but can also be arranged at another suitable point. A particularly compact embodiment of the energy provision device is implemented by the arrangement of the common network rectifier device and the common inverter and also—optionally—the connection of the first connection device on or in the housing.

Furthermore a method is described for operating an energy provision device for providing electrical energy for a motor vehicle, in particular an energy provision device according to the statements in the context of this description, wherein the energy provision device comprises a network connection for connecting the energy provision device to an AC network, at least one first connection device for creating a wired electrical connection between the network connection and the motor vehicle, and at least one second connection device for creating a wireless electrical connection between the network connection and the motor vehicle, wherein the first connection device has a connection for connecting an electrical line provided for creating the wired connection to the motor vehicle and/or the electrical line connected to the connection and the second connection device has a wireless charging device. It is provided here that the first connection device and the second connection device are connected via a common network rectifier device and a common inverter of a potential isolation device to the network terminal.

The advantages of such an embodiment of the provision device or such a procedure have already been noted. Both the energy provision device and also the method for its operation can be refined according to the statements in the context of this description, so that reference is thus made thereto.

According to the invention, it is provided, for example, that a suitable operating mode be selected from the above-mentioned operating modes, i.e., the first operating mode and the second operating mode, and set on the rectifier device. For this purpose, it is provided in particular that the switching device, which was also already mentioned, be set accordingly. This enables particularly flexible operation of the energy provision device.

### BRIEF DESCRIPTION OF THE FIGURE(S)

The invention will be explained in greater detail hereinafter on the basis of the exemplary embodiments illustrated in the drawing, without restricting the invention. In the drawing, the single

FIGURE shows a schematic illustration of an energy provision device for providing electrical energy for a motor vehicle.

### DETAILED DESCRIPTION

The FIGURE shows a schematic illustration of an energy provision device 1, which is provided and designed for providing electrical energy for a motor vehicle (not shown in greater detail). The energy provision device 1 comprises a housing 2, in which essential components are arranged. Furthermore, the energy provision device 1 comprises a network connection 3 for connecting the energy provision device 1 to an AC network, preferably a public AC network. In the exemplary embodiment shown here, the network connection 3 is embodied as three-phase.

Furthermore, the energy provision device 1 comprises a first connection device 4 and a second connection device 5. The first connection device 4 is provided and designed for creating a wired electrical connection between the network connection 3 and the motor vehicle, whereas the second connection device 5 is provided and designed for creating a wireless electrical connection between the network connection 3 and the motor vehicle. The first connection device 4 has a first connection 6 and the second connection device 5 has a second connection 7. The first connection 6 and—optionally—also the second connection 7 are preferably each designed as a plug fitting.

An electrical line 8 is connectable to the connection 6, via which ultimately the electrical connection to the motor vehicle can be created. For example, the line 8 has a plug 9 or the like on its end facing away from the first connection 6 for electrically connecting the line 8 to the motor vehicle. A wireless charging device 11 is connected to the second connection 7—preferably by means of a line 10. The wireless charging device 11 is provided, for example, in the form of a coil.

The first connection device 4 and the second connection device 5 are connected via a common network rectifier device 12 to the network connection 3. In the exemplary embodiment shown here, the network rectifier device 12 has a single network rectifier 13. Alternatively, of course, multiple network rectifiers 13 can also form a component of the network rectifier device 12, wherein these network rectifiers 13 are preferably electrically connected in parallel to one another. The network rectifier 13 is connected to the network connection 3, on the one hand. On the other hand, it is connected to the first connection device 4 and the second connection device 5 or the corresponding connection 6 or 7, respectively, specifically via a common inverter 14, which is a component of a potential isolation device 15.

The potential isolation device 15 has an isolation transformer 16 and a rectifier 17 in addition to the inverter 14. Optionally, at least one electrical component can be provided which is, for example, a component of a resonant circuit and/or a filter. The isolation transformer 16 of the potential isolation device 15 is used to implement a galvanic isolation, in particular a protective isolation, of at least the first connection device 4 from the network connection 3 or the network rectifier 13. For this purpose, the first connection device 4 is electrically connected via the rectifier 17, the isolation transformer 16, the component 18 (if provided), and the inverter 14 to the network rectifier 13, specifically in the indicated sequence.

In contrast, the second connection device 5 is connected over only a part of the potential isolation device 15 to the network connection 3 or the network rectifier device 12, namely at least not to the rectifier 17. For example, the connection device 5 is thus connected via the isolation transformer 16 (optionally), the at least one component 18 (also optionally), and the inverter 14 to the network connection 3 or the network rectifier device 12.

In the exemplary embodiment shown here, the second connection device 5 is connected to a connection point 19, which is located between the inverter 14 and the rectifier 17, in particular between the inverter 14 and the isolation transformer 16. Such an embodiment of an energy provision device 1 has the advantage that the inverter 14 of the potential isolation device 15 is used, on the one hand, for the galvanic isolation of the connection device 4 from the network rectifier device 12 and, on the other hand, for the provision of an alternating current for the second connection device 5.

To alternately operate the first connection device 4, the second connection device 5, or both connection devices 4 and 5, a switching device 20 is connected to the connection point 19, which has a first switch 21 for the first connection device 4 and a second switch 22 for the second connection device 5. The first switch 21 is connected, on the one hand, to the connection point 19 and, on the other hand, to the first connection device 4, specifically via at least one rectifier 17, in the exemplary embodiment shown here additionally also via the isolation transformer 16 (optionally). The second switch 22 is connected, on the one hand, to the connection point 19 and, on the other hand, to the second connection device 5.

The described energy provision device 1 has the advantage that a high degree of integration is achieved in that the connection devices 4 and 5 are supplied with electric current via the common network rectifier device 12 and the inverter 14. Moreover, the essential components of the energy provision device 1 are arranged in the common housing 2.

1-10. (canceled)

11. An energy provision device for providing electrical energy for a motor vehicle, comprising: a network connection for connecting the energy provision device to an AC network, at least one first connection device for creating a wired electrical connection between the network connection and the motor vehicle, and at least one second connection device for creating a wireless electrical connection between the network connection and the motor vehicle, wherein the first connection device has a connection for connecting an electrical line provided for creating the wired connection to the motor vehicle and/or the electrical line connected to the connection and the second connection device has a wireless charging device, wherein the first connection device and the second connection device are connected to the network connection via a common network rectifier device and a common inverter of a potential isolation device, wherein the potential isolation device has a rectifier electrically connected on the input side to the inverter and on the output side to the first connection device as well as an isolation transformer including a primary winding electrically connected to the inverter and a secondary winding electrically connected to the first connection device, and wherein the second connection device is electrically connected to the potential isolation device between the inverter and the rectifier.

12. The energy provision device as claimed in claim 11, wherein the network rectifier device has a network rectifier, which is electrically connected, on the one hand, to the network connection and, on the other hand, via the common inverter in parallel to the first connection device and the second connection device.

13. The energy provision device as claimed claim 11, wherein the network rectifier is designed to rectify an electric current provided at the network connection with a network frequency and the inverter provides electric current on the output side at an intermediate circuit frequency which is greater than the network frequency.

14. The energy provision device as claimed in claim 11, wherein the wireless charging device is designed for the intended operation at a transfer frequency and the intermediate circuit frequency corresponds to the transfer frequency.

15. The energy provision device as claimed in claim 11, wherein at least one electrical component of a resonant circuit and/or a filter and/or a compensation network is electrically connected between the inverter and the isolation transformer.

16. The energy provision device as claimed in claim 11, wherein the second connection device is electrically connected to the potential isolation device between the inverter, in particular the at least one electrical component, and the rectifier, in particular the isolation transformer.

17. The energy provision device as claimed in claim 11, wherein the first connection device and the second connection device are connected via a switching device to the inverter.

18. The energy provision device as claimed in claim 11, wherein the switching device has at least one switch, which is electrically connected, on the one hand, to a connection point provided between the inverter and the rectifier to the potential isolation device and, on the other hand, to the first connection device and/or the second connection device.

19. The energy provision device as claimed claim 12, wherein the network rectifier is designed to rectify an electric current provided at the network connection with a network frequency and the inverter provides electric current on the output side at an intermediate circuit frequency which is greater than the network frequency.

20. The energy provision device as claimed in claim 12, wherein the wireless charging device is designed for the intended operation at a transfer frequency and the intermediate circuit frequency corresponds to the transfer frequency.

21. The energy provision device as claimed in claim 13, wherein the wireless charging device is designed for the intended operation at a transfer frequency and the intermediate circuit frequency corresponds to the transfer frequency.

22. The energy provision device as claimed in claim 12, wherein at least one electrical component of a resonant circuit and/or a filter and/or a compensation network is electrically connected between the inverter and the isolation transformer.

23. The energy provision device as claimed in claim 13, wherein at least one electrical component of a resonant circuit and/or a filter and/or a compensation network is electrically connected between the inverter and the isolation transformer.

24. The energy provision device as claimed in claim 14, wherein at least one electrical component of a resonant circuit and/or a filter and/or a compensation network is electrically connected between the inverter and the isolation transformer.

25. The energy provision device as claimed in claim 12, wherein the second connection device is electrically connected to the potential isolation device between the inverter, in particular the at least one electrical component, and the rectifier, in particular the isolation transformer.

26. The energy provision device as claimed in claim 13, wherein the second connection device is electrically connected to the potential isolation device between the inverter, in particular the at least one electrical component, and the rectifier, in particular the isolation transformer.

27. The energy provision device as claimed in claim 14, wherein the second connection device is electrically connected to the potential isolation device between the inverter, in particular the at least one electrical component, and the rectifier, in particular the isolation transformer.

28. The energy provision device as claimed in claim 15, wherein the second connection device is electrically connected to the potential isolation device between the inverter, in particular the at least one electrical component, and the rectifier, in particular the isolation transformer.

29. The energy provision device as claimed in claim 12, wherein the first connection device and the second connection device are connected via a switching device to the inverter.

30. The energy provision device as claimed in claim 13, wherein the first connection device and the second connection device are connected via a switching device to the inverter.
